(19) United States
(12) Patent Application Publication
(10) Pub. No.: US 2026/0339124 A1
(43) Pub. Date: Oct. 29, 2026

(54) Improved Multifocal Lens, Lens System, and Lens Kit

(71) Applicant: Brien Holden Vision Institute Limited, Sydney, NSW (AU)

(72) Inventors: Arthur Back, Sydney, NSW (AU); Durgasri Jaisankar, Sydney, NSW (AU)

(21) Appl. No.: 19/115,149

(22) PCT Filed: Sep. 26, 2023
(86) PCT No.: PCT/IB2023/059508

§ 371 Date: Mar. 25, 2025

Related U.S. Application Data
(60) Provisional application No. 63/410,418, filed on Sep. 27, 2022.

(51) Int. Cl. G02C 7/04

(52) U.S. Cl. CPC G02C 7/044; G02C 7/042; G02C 2202/24

(57) ABSTRACT

An improved multifocal ophthalmic lens comprising a central optical zone for near vision correction, a first peripheral optical zone incorporating at least one zone that transitions down from the central optical zone's power to a second peripheral optical zone incorporating the distance refractive error correction. At least one of the optical zones may be configured with a non spherical curvature which may provide a substantially constant power profile within at least a portion of the zone. The improved ophthalmic lens may form at least one of the lenses in a system of lenses. The improved ophthalmic lens may form a kit of lenses where a portion of the myopic powers and/or hyperopic powers provide at least one improved ophthalmic lens across a wide range of lens powers in the kit to correct the vision of a low, moderate and/or advanced presbyope.

### CROSS REFERENCE TO RELATED APPLICATIONS

This application claims priority to U.S. Provisional Application No. 63/410,418, filed on Sep. 27, 2022. This disclosure is related to International Application No. PCT/IB2021/057720, filed Aug. 21, 2021, which claims priority to International Application No. PCT/IB2020/057863, filed on Aug. 21, 2020, and U.S. Provisional Application 63/092,199, filed Oct. 15, 2020, and International Application No. PCT/IB2021/055686, filed Jun. 25, 2021. The entire contents of each of the foregoing priority and related applications is incorporated herein by reference in their entirety.

### FIELD

The present invention relates generally to contact lenses, and specifically to multifocal contact lenses.

### BACKGROUND

Accommodation enables a person of normal vision to focus on objects from infinity to a near point, typically of the order of 25 cm or less from the eye. A presbyope has lost the ability to accommodate over such a large range, and typically requires at least two corrections: a distance correction for focusing to infinity, and a near correction for focusing to close objects. Corrections, which are typically different for each eye, are usually prescribed to a quarter of a diopter.

Multifocal spectacles provide the two corrections for each eye, as well as intermediate corrections, in separate regions of one lens. Such spectacles rely on the fact that the spectacle lenses are relatively fixed with respect to the eye, so that the spectacle wearer usually looks through the higher portions of the lens for distant objects, and the lower portion of the lens for near objects.

Multifocal contact lenses that provide both corrections for a particular eye in a single lens are known in the art. However, unlike spectacle lenses, contact lenses move with the motion of the eye. Thus, multifocal contact lenses known in the art use a number of different systems to enable a presbyope to be adequately corrected for viewing both near and distant objects. Unfortunately, not all of these systems have been well received by users, and even the systems that have been well received may still be improved upon.

U.S. Pat. No. 5,125,729, to Mercure, whose disclosure is incorporated herein by reference, describes a lens which has, on its front surface, a central spherical circular area which is surrounded by an annular aspherical area. The central area is responsible for distance vision. The annular aspherical area enables vision at all distances including reading.

U.S. Pat. No. 5,526,071, to Seidner et al., whose disclosure is incorporated herein by reference, describes a diagnostic contact lens. After diagnosis involving an over-refraction process, the patient is fitted with a prescription lens. The prescription lens has two front annular aspheric surfaces, or in the case where intermediate vision is to be accommodated, three (or more) front aspheric surfaces. The distance vision area is a central area of the lens, while the near vision area is one of the annular areas in the periphery of the front surface of the lens.

U.S. Pat. Nos. 5,619,289 and 5,691,797 to Seidner et al., whose disclosures are incorporated herein by reference, describe a lens having a front central aspheric surface for distance vision correction with a diameter of about 1.5-2.5 mm and an eccentricity of about 0.8. A first annular surface surrounding the central surface is aspheric and has a diameter of about 2.0-3.5 mm. Other annular surfaces have diameters of about 2.3-4.0 mm, and 3.5-8.0 mm, and may be spheric or aspheric.

U.S. Pat. No. 5,754,270 to Rehse et al., whose disclosure is incorporated herein by reference, describes a lens having a central aspheric optic zone with a diopter power equal to the distant power correction, plus an add power range from 2.25 to 2.5 diopters from center outward. There is a second “blending zone” concentric with the center zone, that provides a rapid power shift of about −0.5 to about −1.25 diopters over a small distance of about 0 to 0.2 mm, typically about 0.05 mm.

U.S. Pat. Nos. 5,864,379 and 6,540,353 to Dunn, whose disclosures are incorporated herein by reference, describe a lens having a central spherical circular region that is overcorrected for near vision, typically by about 25%-100%, with a diameter of about 1.0-2.5 mm. The central zone is surrounded by up to three annular aspherical zones, the first two having thicknesses of about 0.5 mm, the third having an outer diameter of about 8 mm.

U.S. Pat. Nos. 6,030,077 and 6,260,966 to Sawano et al., whose disclosures are incorporated herein by reference, describe a lens having a central circular spheric region with a first constant power, an intermediate annular aspheric region, and an outer annular spheric region having a second constant power. The radii of different parts of the intermediate region are calculated from two opposing parabolic curves which smoothly connect to each other and to the constant powers of the center and outer zones.

U.S. Pat. No. 6,116,735 to Wada, whose disclosure is incorporated herein by reference, describes a lens having zones which alternate between near-and far-correction zones. Typically there are four zones. A central near-vision zone is approximately 1-2 mm diameter, and the other zones have equal widths of about 0.63 mm.

U.S. Pat. No. 6,929,366 to Perel et al., whose disclosure is incorporated herein by reference, describes a contact lens with a front surface that has a central circular zone, an annular outer zone, and an annular region, intermediate the central and outer zones, having one or more contiguous intermediate annular zones. All of these zones are substantially spherical and generate zone powers, with the central zone power selected so as to correct near vision, and the annular outer zone is less than the central zone power, and the one or more intermediate annular zones generate respective one or more intermediate zone refractive powers in a monotonic progression of decreasing refractive power from the central zone to the annular outer zone.

U.S. Pat. No. 8,777,415 to Back, whose disclosure is incorporated herein by reference, describes multifocal contact lenses and methods to improve the vision of presbyopic patients. The multifocal contact lenses include an optic zone that has an aspheric power profile that provides a near vision refractive power and a distance vision refractive power, and provides an ADD power that corresponds to the difference between the near visions refractive power and the distance vision refractive power. The multifocal contact lenses can improve binocular vision of presbyopic subjects by being prescribed such that the non-dominant eye contact lens is over-corrected for distance vision, and both multifocal contact lenses are under-corrected for the ADD power requirement of the subject.

Multifocal contact lenses with lens zones (e.g., near, distance, intermediate and/or transition zones) formed by spherical curvatures may form a non-constant power profile in the zone e.g., the zone providing a distance vision correction and the power across the distance vision zone may vary substantially by up to several diopters across the zone despite the lens being labeled with a single power representing the distance refractive error correction. In some embodiments, it may be desirable to provide multifocal lenses with a substantially constant power profile and/or reduced lens aberrations and/or improved image quality, which may provide improvements in lens power measurements, lens power labeling, lens manufacturing quality control (“QC”), more consistent lens power profiles across the range of labeled lens powers required for the population and/or allow for more predictable vision performance.

Improvements in manufacturing QC and zone image qualities may lead to increased ease of lens fitting for practitioners by reducing the time taken for trial fitting. More defined patient responses to vision testing during lens power selection procedures may lead to a reduced number of lenses fitted to obtain the final lens power prescribed and/or a simpler, more predictable and/or universal lens selection nomogram across the lens powers provided in the lens kit.

With current multifocal lenses, the measurement of a single power across the relatively small zone size may be variable due to the non-constant power profile in a zone and resultant poor image quality of the focusing target used to determine the focal power in e.g., mire based QC systems. Alternatively, other QC systems, e.g., wavefront based, may average the non-constant power to represent a single labeled power. Accordingly, defining a single lens power to label the distance power of the lens may be less accurate and/or more variable within the production of a single lens power and between different stock keeping units for lens power, resulting in reduced QC tolerances, and the associated variability may be of clinical significance resulting in a less definite endpoint of a refraction assessment by a practitioner to beyond the standardized increments of 0.25 D. Consequently, selecting a lens power for a subject either by a traditional nomogram relating label power and refractive error or alternatively from a trial fitting and over refraction procedures, may be less reliable for a given prescription or between the range of prescriptions covered by lenses within the lens kit.

Current multifocal lenses formed by spherical curvatures may form non-constant power profiles in central and especially peripheral optical zones providing the distance, intermediate, and near vision correction of the presbyope. In some embodiments, it may be desirable to provide a multifocal contact lens to improve vision by attaining a more uniform power profile to reduce optical aberrations in one or more of the central optical zone and peripheral optical zones.

Improved vision from a multifocal lens with a more uniform power profile may result in less interference to in-focus retinal images by out-of-focus images leading to less ghost images and less contrast loss, thereby improving distance and/or near and/or intermediate vision and vision stability including those vision decrements resulting from lens decentration and lens movement, as well as improved night vision by reducing disturbances to lights. Improving night vision may help with night driving quality and eliminate the inconvenience of removing lenses to drive or wearing lenses in lower light levels. Additionally, there may be reduced vision disturbances, more consistent vision performance across the range of visual environments, and more consistent visual experiences across the range of presbyopic prescriptions from across the powers within a lens kit. Thus the practitioner's understanding of individual and group wearer responses to the vision provided by the improved multifocal may aid the predictability of performance and enable more efficient patient management.

Reference to any prior art in the specification is not, and should not be taken as, an acknowledgment or any form of suggestion that this prior art forms part of the common general knowledge in any jurisdiction or that this prior art could reasonably be expected to be ascertained, understood and regarded as relevant by a person of skill in the art.

### SUMMARY

Some embodiments are directed to an improved multifocal contact lens.

Some embodiments are directed to an improved multifocal contact lens, formed of a transparent polymer material e.g., a hydrogel, silicone hydrogel and/or a rigid gas permeable polymer and comprising a rear surface having a base curve which is adapted to fit to the eye of a wearer, and a front surface comprising a plurality of optical zones. A central optical zone is formed so that the refractive power of the central zone is at least a more positive power than required to correct the wearer's far distance refractive error e.g., the central zone power value may be set to correct the wearer's near point refractive error i.e. the positive power added to the distance refractive error referred to as the near addition or ADD power. An annular outer peripheral optic zone is configured to have an outer peripheral optic zone power that is less positive than the central zone refractive power e.g., a power value that corrects the distance refractive error. A plurality of intermediate peripheral optic zones are formed between the central zone and the outer peripheral optic zone. The power of each intermediate peripheral optic zone may be configured to lie between the central and annular outer peripheral optic zone powers, each intermediate peripheral optic zone power being set so that the powers of all the zones form a progression in power change from the central zone to the outer peripheral optic zone. The progression of power between the central and outer peripheral optic zone may be monotonic or non-monotonic or periodic or aperiodic or smooth or stepwise or linear or curvilinear or any combination thereof and generally reduces in positive power over the intermediate optical zones. The intermediate peripheral optic zone incorporates at least one zone that transitions the power from the central optical zone to the outer peripheral optic zone incorporating the distance refractive error correction.

In certain embodiments, the optical zones (e.g., the center zone, intermediate peripheral optic zones and/or the outer peripheral optic zone) may be configured with at least one non spherical curvature e.g., an entirety or a segment or strip of an asphere, extended odd polynomial, extended even polynomial, conic section, biconic section, toric surface, Zernike polynomials, superconics, a logarithmic function, an exponential function, a trigonometrical (e.g. sine, cosine) function, a fourier series, a conic function, a polynomial function, a power function, a wavelet function, a Bezier curve, a spline curve (e.g. basic spline, or cubic spline, etc) or spline surface, a trochoid, a cycloid (e.g. epicycloid), a catenary and/or any pre-definable mathematical function or combinations of such functions that is algebraic or non-algebraic, and may provide a substantially flat, e.g., constant, power profile within at least a portion of the zone.

Some embodiments are directed to a system of lenses where the improved ophthalmic contact lens forms at least one of the lenses in a system of lenses, e.g., one of a pair of lenses.

Some embodiments are directed to a kit of lenses, where the improved ophthalmic contact lens may form a kit of lenses, where a portion of the myopic and/or hyperopic powers provide at least one improved ophthalmic lens that may span a wide range of lens powers in the kit. In some embodiments, there may be 4, 6, 8, 10, 12, 14, 16, 18, or 20 myopic and/or hyperopic powers or more, or other reasonable numbers in that range.

In some embodiments, the wide range of lens powers provided in the outer peripheral optic zone and correcting the distance refractive error that the improved ophthalmic contact lens may cover in a lens kit may include +/−10.0 D or +/−15.0 D or a subset of the distance refractive lens powers in the lens kit combined with center zone powers providing at least one or more ADD powers to correct the near vision of a low and/or a moderate and/or an advanced presbyope e.g., a +1 D ADD or a +1.5 D ADD or a +2 D ADD or +2.5 D ADD or higher.

Some embodiments are directed to an improved ophthalmic lens for presbyopia correction comprising a central optical zone incorporating a lens power with at least a more positive power than required to correct a far distance refractive error, a first peripheral optical zone incorporating one or more zones with at least a lower power than the central optical zone power and wherein at least one of the successive zones has a lower power, e.g. less positive power, than any preceding zone, a second peripheral optical zone incorporating a lens power with at least a power required to correct the far distance refractive error; and wherein at least one of the curvatures forming the central optical zone and/or any of the zones of the first peripheral optical zone and/or the second peripheral optical zone is not spherical.

In some embodiments, the junctions between the zones may be substantially sharp or unblended, and the shape or smoothness of the junctions may be substantially produced by applying a molding or an unblended transition during a lathe cutting process to the lens. In some embodiments, the junctions between the zones may not be substantially sharp and may be blended and the junction may be smooth either through the manufacturing process or by designing a blending or smoothing feature e.g., a narrow curvature between the zones. In some embodiments, the power progression from the central zone to the second peripheral zone and/or any zones in between may be defined by any mathematical function giving values of the one or more intermediate zone refractive powers relative to the central zone refractive power and the second peripheral optical zone refractive power, and the dimensions of the zones. In some embodiments, the power progression may be smooth and continuous and in certain embodiments the power progression may not be smooth and continuous. In some embodiments, the power progression is stepwise.

In some embodiments, the monotonic power progression is a progression chosen from a geometric progression and a logarithmic progression. In some embodiments, the monotonic power progression consists of a substantially linear progression. In some embodiments, the monotonic power progression is periodic or aperiodic. In some embodiments, the progression is non monotonic and the progression is chosen from a predefined function. In some embodiments, the non-monotonic power progression is periodic or aperiodic.

The present disclosure may be more fully understood from the following detailed description of the embodiments thereof, taken together with the drawing, a brief description of which follows.

### BRIEF DESCRIPTION OF THE DRAWINGS

The accompanying drawings and figures facilitate an understanding of the various embodiments of this invention.

FIG. 1 illustrates plan and cross-sectional views of a multifocal contact lens configured with non spherical curvatures.

FIG. 2 depicts power profiles of a multifocal contact lens configured with non spherical curvatures.

FIG. 3 depicts power profiles of a multifocal contact lenses configured with spherical curvatures.

FIG. 4 depicts power profiles of multifocal contact lenses configured with non spherical curvatures in a lens kit.

FIG. 5 depicts power profiles of multifocal contact lenses configured with spherical curvatures in a lens kit.

FIG. 6 depicts power profile metrics and design dimensions of the multifocal contact lenses configured with non spherical curvatures.

FIG. 7 depicts a table of power profile metrics of the multifocal contact lenses configured with non spherical curvatures.

FIG. 8 depicts power profile metrics and design dimensions of the multifocal contact lenses configured with spherical curvatures.

FIG. 9 depicts a table of power profile metrics of the multifocal contact lenses configured with spherical curvatures.

FIG. 10 depicts power profiles of multifocal contact lenses configured with non spherical curvatures and controlled power profiles in a lens kit.

FIG. 11 depicts a table of power profile metrics of the multifocal contact lenses configured with non spherical curvatures and controlled power profiles.

FIG. 12 depicts power profiles of multifocal contact lenses configured with non spherical curvatures and controlled power profiles in a lens kit.

FIG. 13 depicts a table of power profile metrics of the multifocal contact lenses configured with non spherical curvatures and controlled power profiles.

### DETAILED DESCRIPTION

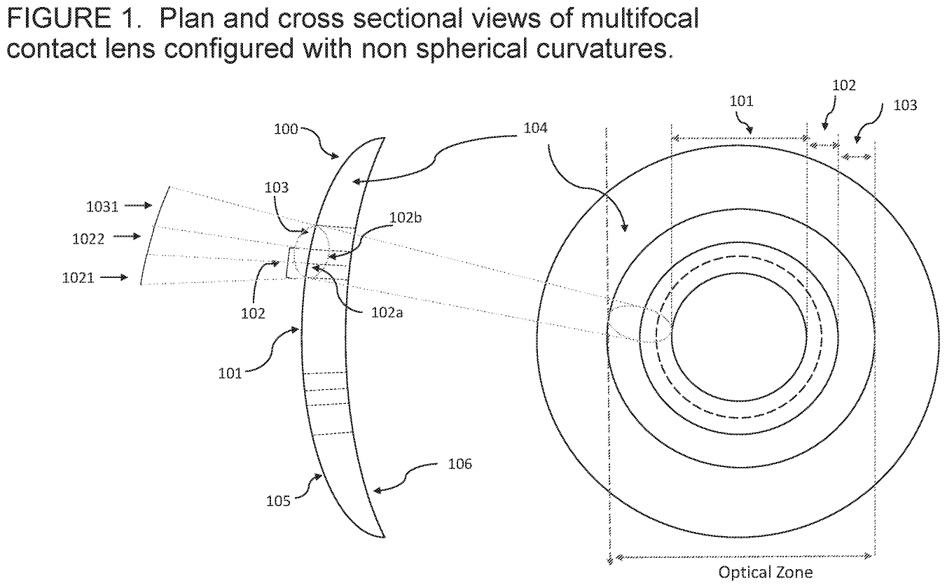

Reference is now made to FIG. 1, which illustrates plan and cross-sectional views of a multifocal ophthalmic contact lens configured with non-spherical curvatures. The multifocal lens may be formed from a hydratable transparent material that is known in the art as being used to produce contact lenses, and that is typically used for producing “soft” contact lenses. The multifocal lens may be produced from any other transparent material, such as glass or plastic, that is adapted to produce contact lenses, such as material known in the art for producing “rigid gas permeable” contact lenses.

After production, dimensions of the multifocal lens may alter, typically when the material of the lens hydrates, to “wet” dimensions, which are the dimensions of the lens under normal use. Unless otherwise stated, dimensions of the multifocal lens given hereinbelow are wet dimensions.

The multifocal lens with a base power profile 100 comprises a front surface 105, a back surface 106, a central optical zone 101, a first peripheral (intermediate) optical zone 102 and a second peripheral (outer) optical zone 103, and an outer non optical zone 104. The back surface 106 is formed as a base curvature to fit the eye of the user of the lens and may be formed with at least one spherical or non spherical curvature. The multifocal lens comprises a plurality of annular concentric (e.g., rotationally symmetric or asymmetric) zones which provide optical correction for the eye of the wearer. At least one of the front surface zones and/or back surface may be formed by a non-spherical curvature i.e. a curvature that is not a sphere. The outer zone 104, acts as an optically inactive carrier for the optical zones, and which typically has an outer diameter corresponding to the overall diameter of the multifocal lens. In some embodiments, the outer zone diameter may start at 6.0 mm and end at 15.0 mm, e.g., 7.5 mm to 14.5 mm or 7.0 mm to 14.0 mm or the outer zone may start from 5.0 mm to 10.0 mm and the overall diameter may be from 13.0 mm to 16.0 mm e.g., 13.5 to 15 mm or e.g., 14.0 to 14.5 mm.

The central zone 101, may have a diameter of 0.2, 0.25, 0.3, 0.35, 0.4, 0.45, 0.5, 0.75, 1.0, 1.25 1.5, 1.75, 2.0, 2.25, 2.5, 2.75, 3.0, 3.25, 3.5, 3.75, or 4.0 mm, or other reasonable numbers in that range. The central zone 101 may be formed by a surface curvature e.g., a non spherical curvature, to form a power profile that when combined with the back surface curvature 106, the lens thickness and refractive index may produce at least one focal point along the optical axis. A central zone curvature has a value so that a central zone refractive power, which is a function of the central zone 101 curvature and the back surface curvature 106, is substantially constant and is approximately equal to the near refractive error correction of the lens wearer. The central zone 101 power may be at least 0.25 D more positive in power than required to correct the far distance refractive error.

The second peripheral optical zone 103 is formed to have an outer zone curvature e.g., a non spherical curvature that, when taken with the back surface curvature, gives a second peripheral optical zone refractive power that is a value less than the central zone 101 power e.g., a power to correct the distance refractive error of the wearer and may be in the range of +/−10.0 D or +/−15.0 D.

Between the central zone 101 and the second peripheral optical zone 103, is the first peripheral optical zone 102 consisting of the intermediate peripheral optical zones 102a and 102b. The first peripheral zone 102 may be contiguous with central zone 101. The second peripheral optical zone 103 may be contiguous with the first peripheral zone 102 and the outer non optical zone 104. In some embodiments, the second peripheral optical zone 103 may not be contiguous with the first peripheral zone 102 and/or the outer non optical zone 104. The first peripheral zone 102 incorporates a plurality of annular intermediate optical zones 102a and 102 b that may have a width of 0.05, 0.06, 0.07, 0.08, 0.09, 0.1, 0.125, 0.15, 0.175, 0.2, 0.25, 0.3, 0.35, 0.4, 0.45, 0.5, 0.6, 0.7, 0.8, 0.9, 1, 1.1, 1.2, 1.3, 1.4, 1.5, 1.6, 1.7, 1.8, 1.9, or 2.0 mm, or other reasonable number in that range. The peripheral annular intermediate optical zones 102a and 102b may be located on the front surface 105 and may be formed by corresponding non spherical (e.g., aspheric) curvatures 1021 and 1022. At least one of the annular optical zones 102 a and/or 102 b may be at least 0.125 D (e.g., at least 0.25 D) less positive than the central zone 101 power and at least one of the successive zones may be at least 0.125 D (e.g., at least 0.25 D) less positive than any preceding conjoined zone in the first peripheral optical zone 102. The second peripheral optical zone 103 may have a width of 0.05, 0.06, 0.07, 0.08, 0.09, 0.1, 0.125, 0.15, 0.175, 0.2, 0.3, 0.4, 0.5, 1.0, 1.25, 1.5, 1.75, 2.0, 2.25, 2.5, 2.75, 3.0, 3.25, 3.5, 3.75, 4.0, 4.25, 4.5, 4.75, or 5.0 mm, or other reasonable number in that range. The second peripheral optical zone 103 may be located on the front surface 105 and may be formed by a corresponding non spherical (e.g., aspheric) curvature 1031.

The first intermediate peripheral optical zone 102a may be formed to have a first zone curvature, which, when taken with the back surface curvature, produces a first zone power. The second intermediate peripheral optical zone 102b may be formed to have a second zone curvature R_{2b}, which, when taken with the back surface curvature, produces a second zone power.

The central zone 101 and/or at least one of the annular intermediate peripheral zones 102a and/or 102b and/or the second peripheral optical zone 103 form a substantially constant power for any power or for a portion of or a substantial portion of the lens powers, for example 10% or more, 20% or more, 40% or more, 50% or more, or 75% or more across the power range of myopic and/or hyperopic powers and/or both myopic and hyperopic powers in the range of +/−8 D, or +/−10.0 D or +/−15.0 D.

In some embodiments at least one of the curvatures forming the central zone 101 and/or any of the peripheral optical zones 102 and 103 may be aspherical. At least one of the curvatures forming the central zone 101 and/or any of the peripheral zones 102 and 103 may correct at least in part a higher order aberration of the multifocal lens, for example a longitudinal spherical aberration. In some embodiments, at least one of the curvatures forming the central zone 101 and/or any of the peripheral zones 102 and 103 may provide a power profile that may be substantially constant across at least a portion of the optical zone. In some embodiments, at least one of the curvatures forming the central zone 101 and/or any of the peripheral zones 102 and 103 may provide a power profile that may not be substantially constant across at least a portion of the optical zone e.g., the power profile of at least one optical zone may change by 0.5 D or more or by 1.0 D or more or by 1.5 D or more. In some embodiments, at least one of the curvatures forming the central zone 101 and/or any of the peripheral zones 102 and 103 may provide a power profile that may be substantially constant across the lens powers in the kit. In some embodiments, at least one of the curvatures forming the central zone 101 and/or any of the peripheral zones 102 and 103 may provide a power profile that may be controlled across the lens powers in the kit e.g., may have a controlled change in power profile for a series of lens powers of the kit that may be controlled by a mathematical relationship.

In some embodiments, at least one of the curvatures forming the central zone 101 and/or any of the zones of the first peripheral zone 102 and/or the second peripheral zone 103 may be non-coaxial.

In some embodiments, at least one of the curvatures forming the central zone 101 and/or any of the zones of the first peripheral zone 102 and/or the second peripheral zone 103 may form a non-spheroidal torus.

In some embodiments, at least one of the curvatures forming the central zone 101 and/or any of the zones of the first peripheral zone 102 and/or the second peripheral zone 103 may form a spheroidal torus.

In some embodiments, at least one of the curvatures forming the central zone 101 and/or any of the zones of the first peripheral zone 102 and/or the second peripheral zone 103 result in focal points forming on the optical axis in front of, on and/or behind the retinal plane (e.g., by using spheroidal, or non-spheroidal torus or multi-spherical curvatures or by tilting curvatures or by using curvatures or lines curvatures to form zones that may be relatively more positively or relatively more negatively powered than the distance refractive error).

In some embodiments, at least one of the curvatures forming the central zone 101 and/or any of the zones of the first peripheral zone 102 and/or the second peripheral zone 103 may form off-axis focal points in front of, on, and/or behind the retinal plane (e.g., by curves and/or lines on either or both surfaces of the lens).

In some embodiments, the surface geometry of the at least one of the curvatures forming the central zone 101 and/or any of the zones of the first peripheral zone 102 and/or the second peripheral zone 103 may result in off-axis focal points in front of, on, and/or behind the retinal plane.

In some embodiments, the at least one of the curvatures forming the central zone 101 and/or any of the zones of the first peripheral zone 102 and/or the second peripheral zone 103 that forms on-axis and/or off-axis focal points in front of, on, and/or behind the retinal plane may be present on one or more lenses in a kit of lenses.

In some embodiments, at least one of the curvatures forming the central zone 101 and/or any of the zones of the first peripheral zone 102 and/or the second peripheral zone 103 may be non rotationally symmetrical.

In some embodiments, at least one of the curvatures forming the central zone 101 and/or any of the zones of the first peripheral zone 102 and/or the second peripheral zone 103 may be only partially applied to a zone e.g. to only a portion of the annular concentric zone such that less than 360 degrees of the zone has the curvature applied.

The multifocal lens may be produced by any contact lens process known in the art, such as, but not limited to, lathing or molding or spin casting or any combination thereof including for example using one or more of such processes to at least partially form a portion of a surface of the multifocal lens on any lens processing part used in the manufacturing process e.g., a mold tool or a mold or a lens material. Consequently, within specific zones e.g., a central zone e.g., 101, a first peripheral optical zone e.g., 102a, 102b, and a second peripheral optical zone e.g., 103, at least one of the zones may be formed to have a substantially constant power or at least substantially constant power over a portion of at least one of the zones or at least a controlled power profile in at least one of the zones across at least a series of multifocal lenses in the kit e.g., labeled lens powers in the range of +/−8.0 D, +/−10.0 D, +/−15.0 D, +/−20.0 D and/or near addition powers required to correct the near point refractive error of a low, medium and/or high addition presbyope.

In some embodiments, the multifocal lens may include at least one or more toric optical zones on a back surface or a front surface to correct a presbyope with astigmatism. In some embodiments, the at least one toric optical zone of the multifocal lens is formed by at least one non spherical curvature in at least one meridian of the lens to provide a power profile that is substantially constant along the at least one meridian. In some embodiments, the toric multifocal lens is designed with lens orientation features e.g., a rotationally asymmetric thickness profile commonly referred to as a ballast to align the cylindrical axis of the lens astigmatic power to about the astigmatism of the eye of the wearer during use. Any type of orientation features may be used e.g., a prism ballast, an iso thickness prism ballast (or is at least in part an iso thickness prism ballast), a non iso thickness prism ballast, at least one thin region, inferior and/or horizontal and/or inferior oblique thickened regions, superior thinned regions or any combinations thereof. In some embodiments, the orientation features may be located in one or more optical zones or may be located peripherally outside the optical zones.

In some embodiments, the multifocal lens includes whole numbers of first peripheral intermediate optical zones other than two, wherein the powers of such first peripheral intermediate optical zones form, when taken together with the central zone power and the second peripheral optical zone power, a monotonic progression. In some embodiments, the multifocal lens includes whole numbers of first peripheral intermediate optical zones other than two, wherein the powers of such first peripheral intermediate optical zones form, when taken together with the central zone power and the second peripheral optical zone power, a non monotonic progression. In some embodiments, the multifocal lens comprises whole numbers of first peripheral intermediate optical zones other than two, wherein the powers of such first peripheral intermediate optical zones form, when taken together with the central zone power and the second peripheral optical zone power, a periodic progression. In some embodiments, the multifocal lens comprises whole numbers of first peripheral intermediate optical zones other than two, wherein the powers of such first peripheral intermediate optical zones form, when taken together with the central zone power and the second peripheral optical zone power, an aperiodic progression.

In some embodiments, the multifocal lens forms at least one lens of a lens system where the multifocal lens is used in a dominant or non-dominant eye of the presbyope.

In some embodiments, the multifocal lens forms at least one lens of a lens system where the multifocal lens is used to correct the vision of a presbyope requiring a low addition e.g., +1 D or a medium addition e.g., +1.75 D or a high addition e.g., +2.5 D.

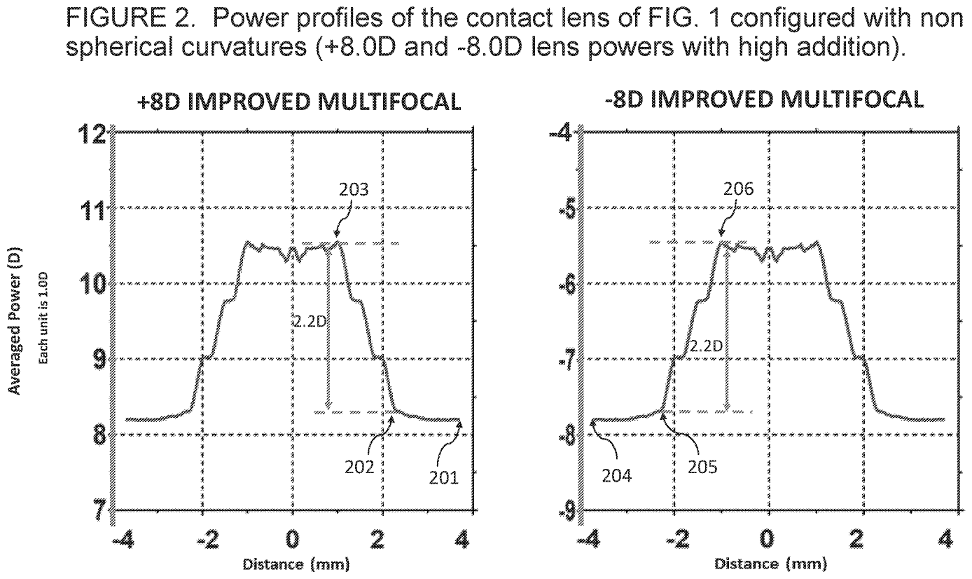

Referring to FIG. 2, the power profile of the multifocal contact lens with a labeled lens power of +8 D and a −8 D in a high addition (e.g., +2.5 D) configured with non spherical curvatures in each zone is depicted.

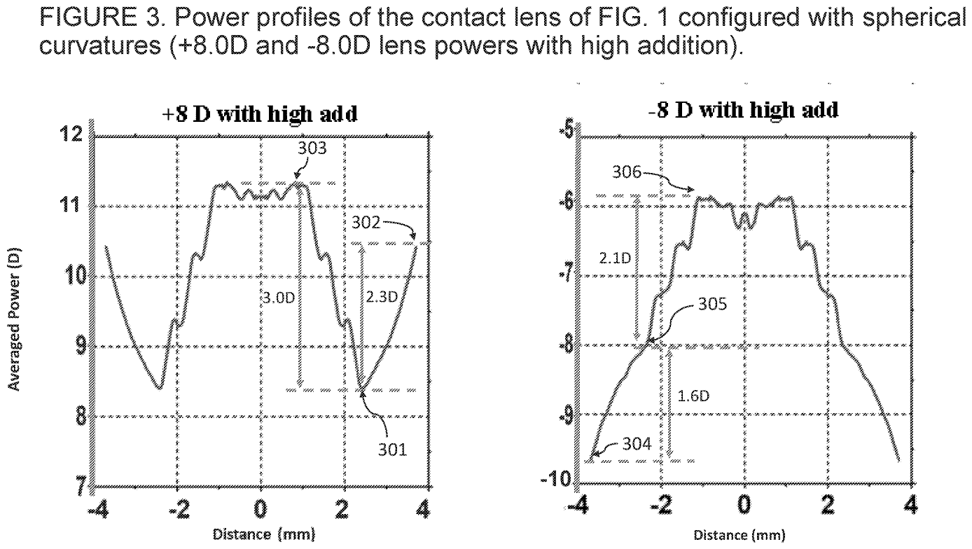

Referring to FIG. 3, the power profile of the multifocal contact lens with a labeled lens power of +8 D and a −8 D in a high addition (e.g., +2.5 D) configured with spherical curvatures in each zone is depicted. Comparing the power profiles of the multifocal lens with non spherical curvatures (FIG. 2) to the multifocal lens with spherical curvatures, there is a difference in uniformity of the power across the optical zones. In the multifocal lens configured with spherical curvatures, the second peripheral optical zone 103 has a power change between 301 and 302 (for the +8 D lens power) of 2.3 D and between 304and 305 (for the −8 D lens power) of 1.6 D and consequently a lens kit comprising multifocal lenses formed by spherical curvatures may vary in the relative position of 302 and 304 (e.g., power profiles normalized relative to the start of the second peripheral optical zone 301 and 305) by up to 3.9 D for the +8 D and −8 D lens powers. Likewise, the difference in lens power between the central optical zone of the +8 D multifocal lens configured with spherical curvatures at 303 and the end of the first peripheral optical zone 301 (the reading addition) is +3 D while the difference in power between the central optical zone of the −8 D lens at 306 and the end of the first peripheral optical zone 304 (the reading addition) is about 1 D lower at 2.1 D. The labeled lens power (distance power and reading addition), representing the average power of the power profile across the second peripheral optical zone 103 (distance power) and the average difference in power between the central zone 101 and the second peripheral zone 103 (addition power), may not accurately represent the power required to correct the distance and near refractive errors of the presbyope across lens powers in the kit. As depicted in FIG. 3, optical zones of a multifocal lens formed by spherical curvatures may form a non-constant power profile in at least one of the optical zones e.g., the second peripheral optical zone providing e.g., the distance vision correction and the power profile may vary across the zone by up to 2.0 D and between lenses in a kit with lens powers ranging from +/−12 D by up to 5.0 D or more. Consequently, the kit comprising the multifocal lenses designed with spherical curvatures may significantly mis-correct the distance and/or near vision of the wearer, depending on their labeled lens power requirement, and may result in blurred vision and visual dissatisfaction of the wearer leaving the practitioner with no ready means to manage the complaint.

In comparison, the power profiles of the improved multifocal lens configured with non spherical curvatures in +8 D and -8D lens powers and of high addition (FIG. 2), the second peripheral optical zone 103 has a power change between 201 and 202 (for the +8 D lens power) and 204 and 205 (for the −8 D lens power) of about OD and consequently a lens kit comprising multifocal lenses formed by the non spherical curvatures may not significantly vary in the relative position of 201 and 204 (e.g., power profiles normalized relative to the start of the second peripheral optical zone 202 and 205) by OD for both the +8 D and −8 D lens powers. Similarly, the difference in power between the central optical zone of the +8 D multifocal lens configured with non spherical curvatures (FIG. 2) at 203 and at the end of the first peripheral optical zone 202 (the reading addition) is 2.2 D while the difference in power between the central optical zone of the −8 D lens at 206 and the end of the first peripheral optical zone 205 (the reading addition) is the same i.e. 2.2 D. In some embodiments, the optical zones of an improved multifocal lens formed by non spherical curvatures may form a constant power profile across at least one of the optical zones (e.g., the second peripheral optical zone providing e.g., the distance vision correction) and/or form a constant difference in power between two optical zones (e.g., the central zone and the second peripheral optical zone) and may not vary substantially between lenses in a lens kit. Thus, the improved multifocal lens may provide a more consistent power profile e.g., within a lens and/or between lenses in a kit, resulting in labeled lens powers that may provide a more accurate and predictable prescribing of lenses to correct the distance and/or near refractive errors of the presbyope and resulting in improved vision performance.

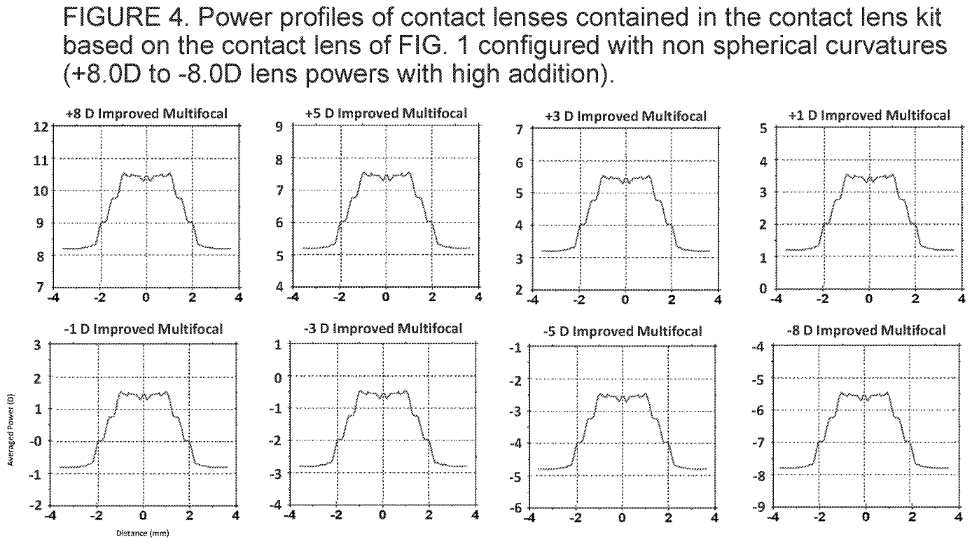

Referring to FIG. 4, a sample of power profiles of multifocal contact lenses with non spherical curvatures (e.g., in the second peripheral optical zone) contained in a contact lens kit is displayed. The sample power profiles of this exemplary kit range from +8.0 D to −8 D lens powers for a high addition (e.g., +2.5 D). In some embodiments, at least one of the multifocal contact lenses with non spherical curvatures (e.g., in the second peripheral optical zone) of a lens kit may be used to correct the distance refractive error in the range of +/−8.0 D, +/−10.0 D, +/−15.0 D, +/−20.0 D, or any other reasonable lens power within that range and a near refractive error to correct a high addition (e.g., +2.5 D).

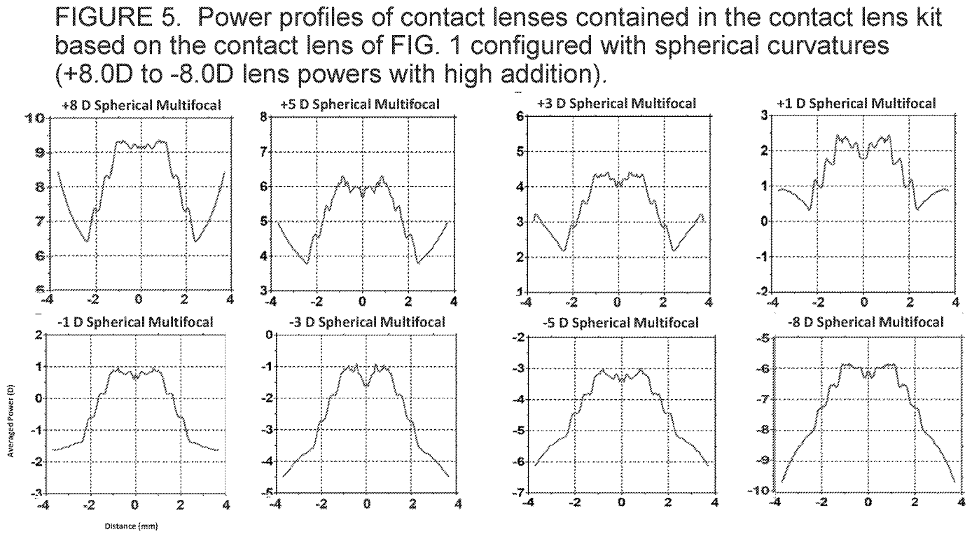

Referring to FIG. 5, a sample of power profiles of multifocal contact lenses with spherical curvatures contained in a contact lens kit is displayed. The sample power profiles of this exemplary kit range from +8.0 D to-8.0 D for a high addition (e.g., +2.5 D). Comparing the power profiles with the multifocal lenses having optical zones formed with non spherical curvatures in FIG. 4, there is a difference in uniformity of the power across the zones, where the multifocal lenses formed with non-spherical curvatures provide a more uniform power across the optical zones.

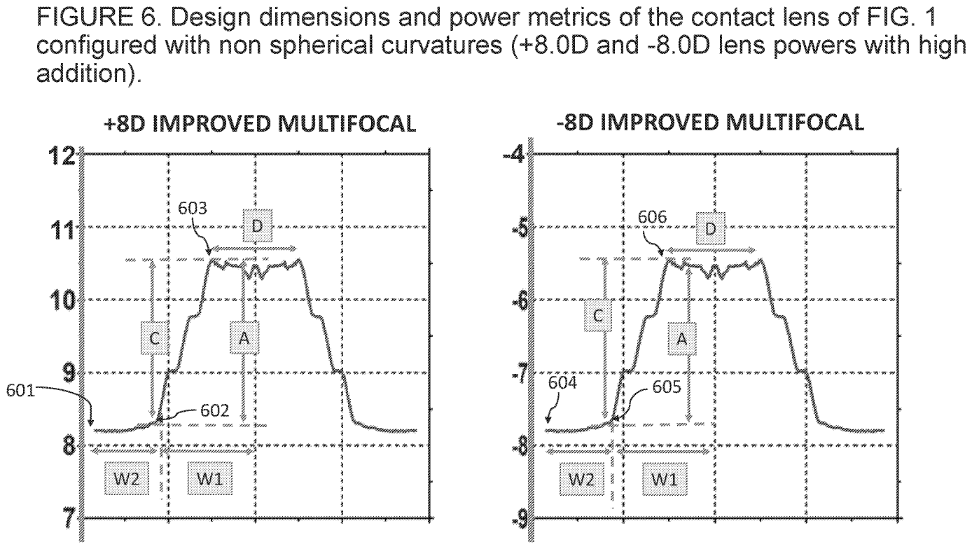

Referring to FIG. 6, power profile metrics and designs dimensions of multifocal contact lenses formed with non spherical curvatures contained in a contact lens kit depicted in FIG. 4 are displayed. The power profile metrics are of a multifocal contact lens with non-spherical curvatures with sample power profiles in the range of +8.0 D to −8.0 D lens powers for a high addition (e.g., +2.5 D). The power metrics used to describe the improved multifocal lens with non spherical curvatures are shown in FIG. 6 and may be as follows: D is the diameter of the central optical zone 101; W1 is the half chord diameter of the central optical zone 101 (D/2) plus the width of the first peripheral optical zone 102; W2 is the width of the second peripheral optical zone 103; C is the addition power calculated as the difference between the central optic zone power e.g., at 603 for a +8 D lens and the end of the start of the second peripheral zone 103 e.g., at 602 for a +8 D lens; B1 is the difference in power across the second peripheral optical zone 103 e.g., between 601 and 602 for a +8 D lens; B2 is the difference in power across zone 103 e.g., between 604 and 605 for a- 8 D lens; A is difference in power calculated between the central optic zone power 101 e.g., at 603 and the end of the second peripheral zone 103 at 601 for a +8 D lens; E is the slope of the power profile across the second peripheral optical zone 103 e.g., between 601 and 602 and is the value determined by dividing B over W 2. The metrics calculated for the improved multifocal lens with non-spherical curvatures of-8D power may follow similar respective calculations as shown for the +8 D lens in FIG. 6.

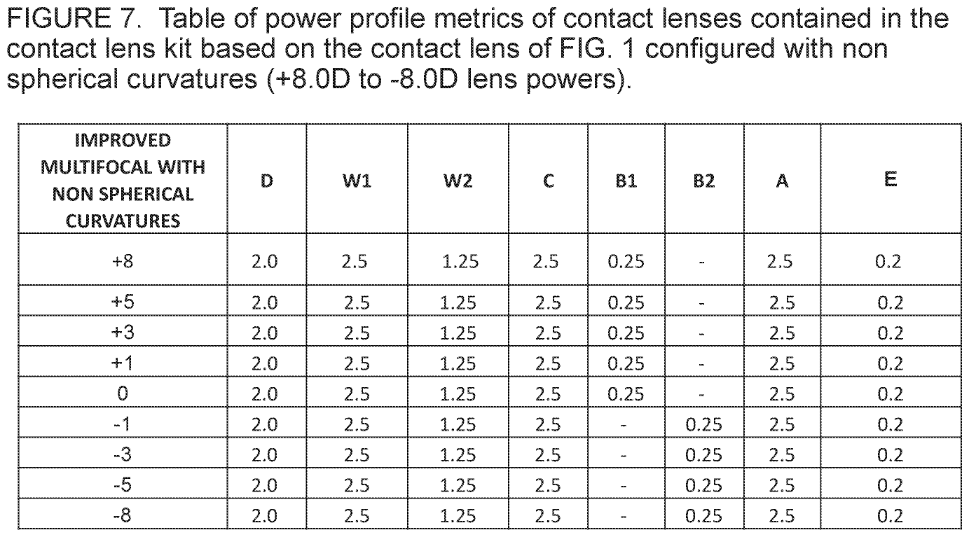

As detailed in FIG. 7, a table of the power metrics of the improved multifocal lens formed with non spherical curvatures shows the power change (B1 and/or B2) across the second peripheral optical (distance) zone 103 (W2) may vary by less than 0.25 D for a power in the range of +8 D to −8 D. Similarly, the power change (B1 and/or B2) across the peripheral optical (distance) zone (W2) may vary by less than 0.25 D for powers between +8 D to −8 D. The power change between the end of the first peripheral optical zone e.g., 602 and the edge of the peripheral optical zone e.g., 601 (E) may be constant e.g., vary in the range OD to +/−0.2 D for powers between +8 D to −8 D. In some embodiments, the slope of the power change across the second peripheral optical zone may be between +/−3 D (e.g., about −3 D, −2.9 D, 2.8 D, −2.7 D, −2.6 D, −2.5 D, −2.4 D, −2.3 D, −2.2 D, −2.1 D, −2 D, −1.9 D, −1.8 D, −1.7 D, −1.6 D, −1.5 D,
1.4 D, −1.3 D, −1.2 D, −1.1 D, −1 D, −0.9 D, −0.8 D, −0.7 D, −0.6 D, −0.5 D, −0.4 D, −0.3 D, −0.2 D,
0.1 D, OD, 0.1 D, 0.2 D, 0.3 D, 0.4 D, 0.5 D, 0.6 D, 0.7 D, 0.8 D, 0.9 D, 1D, 1.1 D, 1.2 D, 1.3 D, 1.4 D, 1.5 D, 1.6 D, 1.7 D, 1.8 D, 1.9 D, 2 D, 2.1 D, 2.2 D, 2.3 D, 2.4 D, 2.5 D, 2.6 D, 2.7 D, 2.8 D, 2.9 D, 3 D).

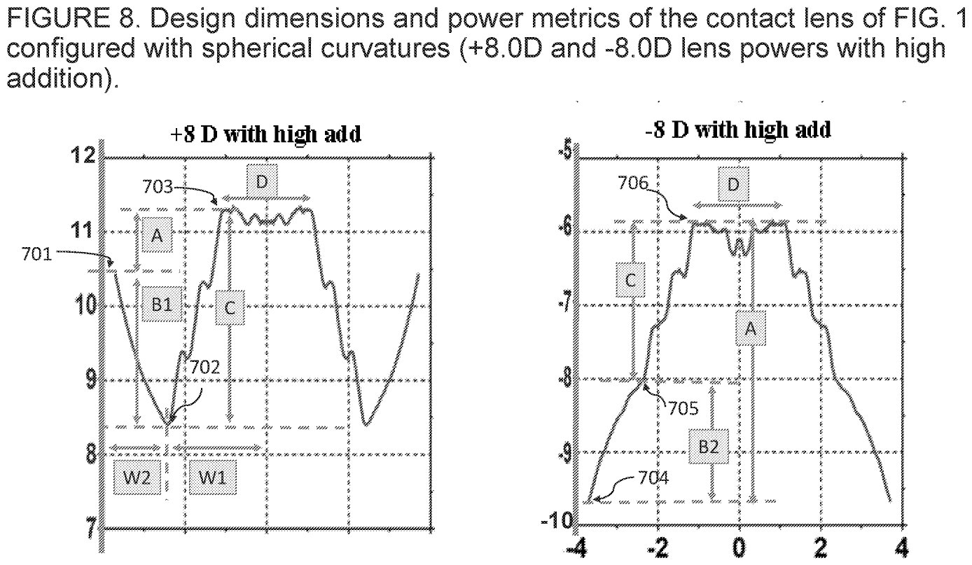

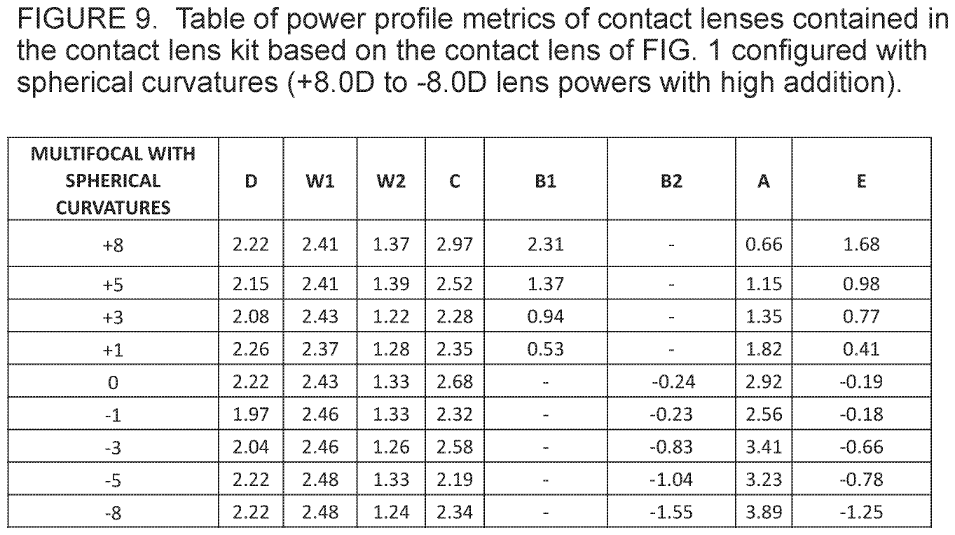

Referring to FIG. 8, power profile metrics and designs dimensions of multifocal contact lenses formed with spherical curvatures contained in a contact lens kit are displayed. The power profile metrics are of a multifocal contact lens with spherical curvatures with sample power profiles in the range of +8.0 D to-8.0 D lens powers for a high addition (e.g., +2.5 D). The power metrics used to describe the multifocal lens with spherical curvatures are shown in FIG. 8 and may be as follows: D is the diameter of the central optical zone 101; W1 is the half chord diameter of the central optical zone 101 (D/2) plus the width of the first peripheral optical zone 102; W2 is the width of the second peripheral optical zone 103; C is the addition power calculated as the difference between the central optic zone power e.g., at 703 for a +8 D lens and the end of the start of the second peripheral zone 103 e.g., at 702 for a +8 D lens; B1 is the difference in power across the second peripheral optical zone 103 e.g., between 701 and 702 for a +8 D lens; B2 is the difference in power across zone 103 e.g., between 704 and 705 for a −8 D lens; A is difference in power calculated between the central optic zone power 101 e.g., at 703 and the end of the second peripheral zone 103 at 701 for a +8 D lens; E is the slope of the power profile across the second peripheral optical zone 103 e.g., between 701 and 702 and is the value determined by dividing B over W2. The metrics calculated for the multifocal lens with spherical curvatures of-8D power may follow similar respective calculations as shown for the +8 D lens in FIG. 9.

As detailed in FIG. 9, a table of the power metrics of the multifocal lens formed with spherical curvatures shows the power change (B1 and/or B2) across the second peripheral optical zone 103 (W2) may vary in the range of +2.31 D to −1.55 D for powers between +8 D to −8 D. The power change between the center zone and the edge of the peripheral optical zone (A) may vary in the range 0.66 D to 3.89 D for powers between +8 D to −8 D. The slope E of power change across the second peripheral optical zone may range from 1.68 to −1.25 for powers between +8 D to −8 D.

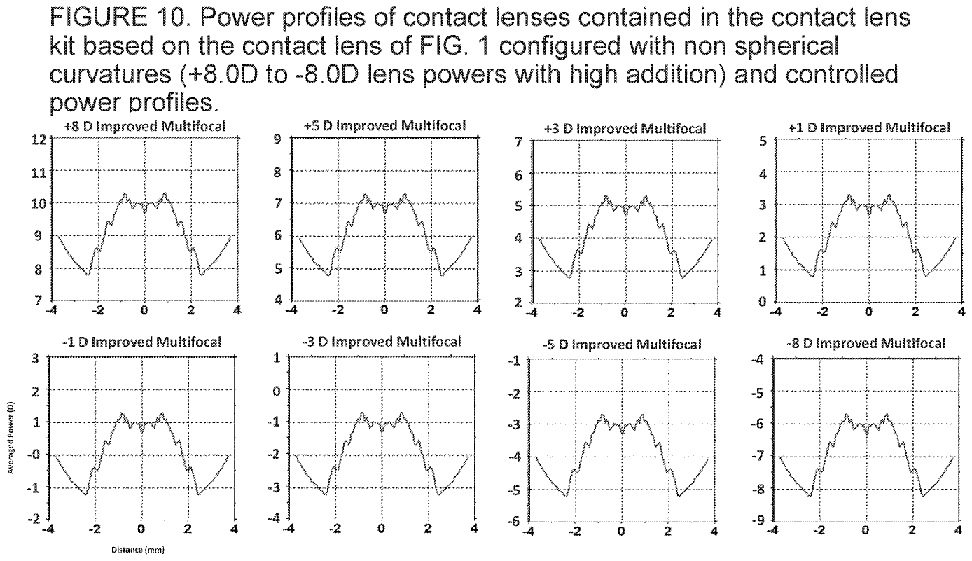

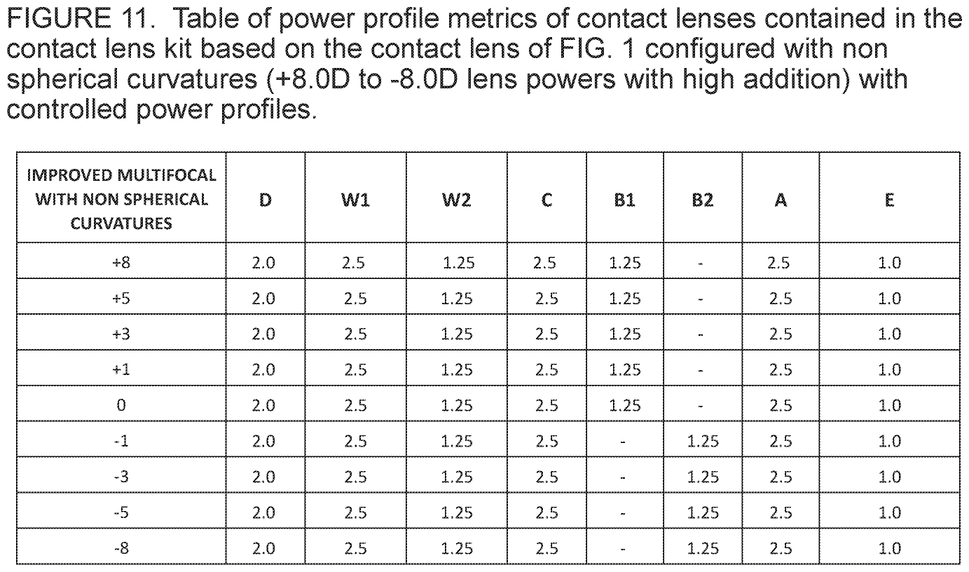

Referring to FIG. 10, a sample of power profiles of multifocal contact lenses with non spherical curvatures (e.g., in the second peripheral optical zone) contained in a contact lens kit is displayed. The sample power profiles of this exemplary kit range from +8.0 D to −8.0 D lens powers for a high addition (e.g., +2.5 D). In some embodiments, at least one of the multifocal contact lenses with non-spherical curvatures (e.g., in the second peripheral optical zone) of a lens kit may be used to correct the distance refractive error in the range of +/−8.0 D, +/−10.0 D, +/−15.0 D, +/−20.0 D, or any other reasonable lens power within that range. FIG. 11 displays a table of power profile metrics of multifocal contact lenses formed with non spherical curvatures with sample power profiles in the range of +8.0 D to −8.0 D lens powers for a high addition (e.g., +2.5 D) contained in the contact lens kit depicted in FIG. 10. The power metrics used to describe the improved multifocal lens with non spherical curvatures have been previously described in FIG. 6. Comparing the power profiles with the sample multifocal lenses formed with non spherical curvatures in the contact lens kit of FIG. 4, the multifocal lenses of FIG. 10 use non spherical curvatures (e.g., different to the non spherical curvatures used for the multifocal lenses in FIG. 4) to provide a non constant power change across at least one of the optical zones (e.g., the second peripheral optical zone 103) and this non constant power profile may be designed with non spherical curvatures to provide consistent power profiles across the range of multifocal lenses in the lens kit.

Referring to FIG. 11, the slope (E) of the power change across the second peripheral optical zone 103 is 1.0 across all the sample multifocal lenses of the contact lens kit displayed in FIG. 10 compared to the slope of 0.2 (FIG. 6) for the multifocal lenses in the contact lens kit displayed in FIG. 4.

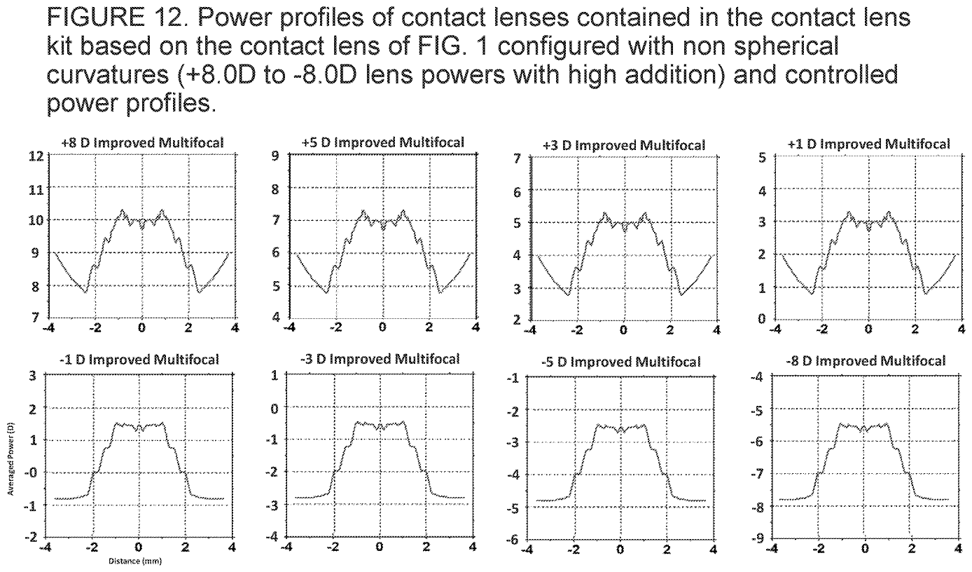

Referring to FIG. 12, a sample of power profiles of multifocal contact lenses with non spherical curvatures (e.g., in the second peripheral optical zone) contained in a contact lens kit is displayed. The sample power profiles of this exemplary kit range from +8.0 D to −8.0 D lens powers for a high addition (e.g., +2.5 D). In some embodiments, at least one of the multifocal contact lenses with non-spherical curvatures (e.g., in the second peripheral optical zone) of a lens kit may be used to correct the distance refractive error in the range of +/−8.0 D, +/−10.0 D, +/−15.0 D, +/−20.0 D, or any other reasonable lens power within that range.

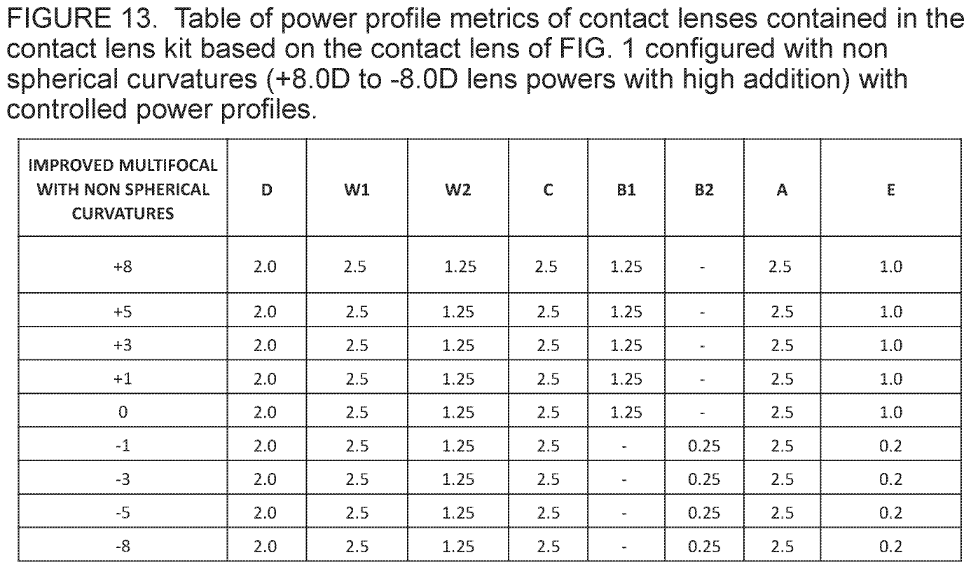

FIG. 13 displays a table of power profile metrics of multifocal contact lenses formed with non-spherical curvatures with sample power profiles in the range of +8.0 D to −8.0 D lens powers for a high addition (e.g., +2.5 D) contained in the contact lens kit depicted in FIG. 12. The power metrics used to describe the improved multifocal lens with non spherical curvatures have been previously described in FIG. 6. Comparing the power profiles with the sample multifocal lenses formed with non-spherical curvatures in the contact lens kit displayed in FIG. 4 and FIG. 10, the multifocal lenses in the contact lens kit displayed in FIG. 12 may use at least one or more different non spherical curvatures to provide selected lens powers (e.g., +8.0 D to +1.0 D) with one form of controlled power profile (e.g., a slope of power change (E) in the second peripheral optical zone 103 of 1.0; FIG. 13) and other selected powers in the kit (e.g., −8.0 D to −1.0 D) with a different form of controlled power profile (e.g., a slope of power change (E) in the second peripheral optical zone 103 of 0.2; FIG. 13). The non spherical curvatures used to form the power profiles of the optical zones of the improved multifocal lenses in a contact lens kit may be selected to provide controlled power profiles in any selected optical zone of any desired shape across any desired subset of multifocal lens powers and/or additions in the contact lens kit.

In some embodiments, the multifocal lens may form at least one lens of a lens kit used to correct presbyopia of a presbyope having a low, moderate and/or high amount of presbyopia. In some embodiments, a multifocal lens with non spherical curvatures may be used as a medium and/or high ADD, and the low ADD may be a multifocal lens with spherical curvatures.

In some embodiments, the multifocal lens with non-spherical curvatures, may form one lens of a lens system or kit used to correct the presbyopia of the presbyope and the other lens of a system or kit may have a progressive power profile (e.g., where at least one optical zone has a power profile that forms a continuous progression in power across the optical zone) or may have at least one optical zone formed with a spherical curvature or at least one curvature forming a non-coaxial optical zone (e.g., an optical zone where at least one focal point is not focused on the optical axis of the multifocal lens) or at least one curvature forming a coaxial optical zone (e.g., an optical zone where at least one focal point is focused on the optical axis of the multifocal lens).

In some embodiments, the multifocal lens with non-spherical curvatures, may form one lens of a lens system or kit used to correct the presbyopia of the presbyope and the other lens of a system or kit may have at least one or more non-coaxial optical zones or may form one or more focal points off the optical axis in front, on or behind the retina or any combination thereof.

In some embodiments, the lens kit may comprise multifocal lenses that incorporate at least one optical zone formed by improved curvatures as disclosed herein and may yield improved aberration control (e.g., coma, astigmatism, and high-order aberration) over a range of conditions including different vergences (e.g., at far, intermediate and/or near vergences), different pupil sizes (e.g., in day or night conditions), in the presence of bright lights at night (e.g., night driving) and/or under different lens centration on the eye (e.g., well centered where the optical center of the lens may be located within 0.1 mm from the visual axis of the eye), and/or under lens decentration from the visual axis of the eye (e.g., by 0.1 mm or more including 0.2 mm, 0.3 mm, 0.5 mm, 0.7 mm and 1.0 mm or more of the lens) that may result from the interaction of the lens geometry, lens material properties and/or the ocular characteristics and biometry of a wearer in static (e.g., primary gaze) and/or dynamic conditions (e.g., with eye gaze, eye movement, and blinking). Aberration control may be determined by applying a mathematical and/or computational model that describes the average human eye performance (e.g. Liou-Brennan, Navarro el. al., Atchison et. al., Campbell model eyes) during lens wear under the aforementioned conditions. The optical performance metrics considered in the improved aberration control may be, for example, the image contrast (e.g., calculated by the Modulation Transfer Function (“MTF”) curves), Zernike aberration terms (e.g., defocus, coma, spherical aberration, astigmatism, trefoil), spot diagrams (e.g., geometric and RMS spot diagrams) and/or image simulations at the image plane (e.g., retina).

In some embodiments, the resulting improved multifocal lens kit that incorporates at least one optical zone formed by improved curvatures as disclosed herein may present improved optical performance metrics relative to the optical performance metrics of an optical zone formed by spherical curvatures by 30%, 35% 40%, 45%, 50%, 55%, 60% 75%, 100%, 200%, 300%, 400% or 500% or more, or other reasonable numbers in that range, (e.g., a second peripheral optical zone 103 for distance vision correction, having an improved MTF unit of more than 30%, 35% 40%, 45%, 50%, 55%, 60%, 65%, 70%, 75%, 80%, 90%, 100%, 110%, 120%, of 130%, or other reasonable numbers in that range).

In some embodiments, the resulting improved multifocal lens kit that incorporates at least one optical zone formed by improved curvatures as disclosed herein may present an improved aberration control (e.g., as measured by microns of coma, diopters of astigmatism) relative to the optical performance metrics induced by an optical zone formed by spherical curvatures by 100%, 250%, 500%, 750%, 1000% or more, or other reasonable numbers in that range.

In some embodiments, the resulting improved multifocal lens kit that incorporates at least one optical zone formed by improved curvatures as disclosed herein may present a more symmetric and uniform spot diagram (geometric and RMS spot diagram variation ratio) relative to the spot diagram of an optical zone formed by spherical curvatures by 5%, 10%, 15%, 20%, 25%, 30%,35%, 40%, 45%, 50%, 55%, or 60% more, or other reasonable numbers in that range.

### EXAMPLES

A1. An ophthalmic lens comprising: a central optical zone incorporating a lens power with at least a more positive power than required to correct a far distance refractive error; a first peripheral optical zone incorporating one or more zones with at least a lower power than the central optical zone wherein at least one of the successive zones has a lower power than any preceding zone; a second peripheral optical zone incorporating a lens power with at least a power required to correct the far distance refractive error; and at least one curvature forming the central optical zone and/or any of the zones of the first peripheral optical zone and/or the second peripheral optical zone is non-spherical.
A2. The lens of any A example, wherein the at least one curvature forming the central optical zone and/or any of the zones of the first peripheral optical zone and/or the second peripheral optical zone may be aspherical.
A3. The lens of any A example, wherein the at least one curvature forming the central optical zone and/or any of the zones of the first peripheral optical zone and/or the second peripheral optical zone may correct at least in part a higher order aberration of the lens.
A4. The lens of any A example, further comprising a lens system wherein at least one lens may be used in a dominant or non-dominant eye of the presbyope.
A5. The lens of any A example, further comprising a lens kit wherein at least one lens may be used to correct the far distance refractive error.
A6. The lens of any A example, wherein the refractive error may be in the range of +/−5 D, +/−8D, +/−10 D, +/−15 D, or +/−20 D.
A7. The lens of any A example, further comprising a lens kit wherein at least one lens may be used to correct the presbyopia of a presbyope having a low, moderate and/or high amount of presbyopia.
A8. The lens of any A example, further comprising a lens system to correct presbyopia wherein at least one lens may have a progressive power profile or a non-coaxial optical zone curvature.
A9. The lens of any A example, further comprising a lens kit to correct presbyopia wherein at least one lens may have a progressive profile or at least one zone formed with a spherical curvature or at least one non-coaxial optical zone curvature or at least one coaxial optical zone curvature.
A10. The lens of any A example, wherein the diameter of the central optical zone may be between 0.25 mm and 4.0 mm (e.g., 0.2, 0.25, 0.3, 0.4, 0.5, 1.0, 1.25 1.5, 1.75, 2.0, 2.25, 2.5, 2.75, 3.0, 3.25, 3.5, 3.75, or 4.0 mm).
A11. The lens of any A example, wherein the width of any of the zones incorporated in the first peripheral optical zone may be between 0.05 mm and 2.0 mm (e.g., 0.05, 0.06, 0.07, 0.08, 0.09, 0.1, 0.125, 0.15, 0.175, 0.2, 0.25, 0.3, 0.35, 0.4, 0.45, 0.5, 0.6, 0.7, 0.8, 0.9, 1, 1.1, 1.2, 1.3, 1.4, 1.5, 1.6, 1.7, 1.8, 1.9, or 2.0 mm).
A12. The lens of any A example, wherein the width of the second peripheral optical zone may be between 0.05 mm and 5.0 mm (e.g., 0.05, 0.06, 0.07, 0.08, 0.09, 0.1, 0.125, 0.15, 0.175, 0.2, 0.3, 0.4, 0.5, 1.0, 1.25, 1.5, 1.75, 2.0, 2.25, 2.5, 2.75, 3.0, 3.25, 3.5, 3.75, 4.0, 4.25, 4.5, 4.75, or 5.0 mm).
A13. The lens of any A example, wherein the central optical zone power may be at least 0.25 D more positive power than required to correct the far distance refractive error.
A14. The lens of any A example, wherein the at least one zone of the first peripheral optical zone may be at least 0.125 D less positive than the central optical zone power and wherein each successive zone is 0.125 D less positive than any preceding zone.
A15. The lens of any A example, wherein the central optical zone power and/or the at least one zone of the first peripheral optical zone and/or the second peripheral optical zone power may form a substantially constant power profile for any power or portion of the optical zone.
A16. The lens of any A example, wherein the portion of the optical zone that has substantially constant power profile may be 10% or more, 20% or more, 40% or more, 50% or more, or 75% or more across the power range of myopic powers and/or hyperopic powers in the range of +/−8.0 D, or +/−10.0 D or +/−15.0 D.
A17. The lens of any A example, wherein the at least one curvature forming the central optical zone and/or any of the zones of the first peripheral optical zone and/or the second peripheral optical zone may be non-coaxial.
A18. The lens of any A example, wherein the at least one curvature forming the central optical zone and/or any of the zones of the first peripheral optical zone and/or the second peripheral optical zone may form on-axis and/or off-axis focal points in front of, on, and/or behind the retinal plane.
A19. The lens of any A example, wherein the at least one curvature forming the central optical zone and/or any of the zones of the first peripheral optical zone and/or the second peripheral optical zone may form a spheroidal torus.
A20. The lens of any A example, wherein the at least one curvature forming the central optical zone and/or any of the zones of the first peripheral optical zone and/or the second peripheral optical zone may form a non-spheroidal torus.
A21. The lens of any A example, wherein the at least one curvature forming the central optical zone and/or any of the zones of the first peripheral optical zone and/or the second peripheral optical zone may form a non rotationally symmetric lens.
A22. The lens of any A example, wherein the at least one curvature forming the central optical zone and/or any of the zones of the first peripheral optical zone and/or the second peripheral optical zone may form a ballasted lens.
A23. The lens of any A example, wherein the at least one curvature forming the central optical zone and/or any of the zones of the first peripheral optical zone and/or the second peripheral optical zone may form a toric lens.

It will be appreciated that the embodiments described above are cited by way of example, and that the present invention is not limited to what has been particularly shown and described hereinabove. Rather, the scope of the present disclosure includes both combinations and sub-combinations of the various features described hereinabove, as well as variations and modifications thereof which would occur to persons skilled in the art upon reading the foregoing description and which are not disclosed in the prior art.

1. An ophthalmic lens comprising:
a central optical zone incorporating a lens power with at least a more positive power than required to correct a far distance refractive error;
a first peripheral optical zone incorporating one or more zones with at least a lower power than the central optical zone wherein at least one of the successive zones has a lower power than any preceding zone;
a second peripheral optical zone incorporating a lens power with at least a power required to correct the far distance refractive error; and
at least one curvature forming the central optical zone and/or any of the zones of the first peripheral optical zone and/or the second peripheral optical zone is non-spherical.

2. The lens of claim 1, wherein the at least one curvature forming the central optical zone and/or any of the zones of the first peripheral optical zone and/or the second peripheral optical zone is aspherical.

3. The lens of claim 1, wherein the at least one curvature forming the central optical zone and/or any of the zones of the first peripheral optical zone and/or the second peripheral optical zone corrects at least in part a higher order aberration of the lens.

4. The lens of claim 1, further comprising a lens system wherein at least one lens is used in a dominant or non-dominant eye of the a presbyope.

5. (canceled)

6. (canceled)

7. The lens of claim 1, further comprising a lens kit wherein at least one lens is use to correct the presbyopia of a presbyope having a low, moderate and/or high amount of presbyopia.

8. The lens of claim 1, wherein the lens forms at least one lens of a lens system to correct presbyopia wherein at least one lens has a progressive power profile or a non-coaxial optical zone curvature.

9. (canceled)

10. The lens claim 1, wherein the diameter of the central optical zone is between 0.25 mm and 4.0 mm.

11. The lens of claim 1, wherein the width of any of the zones incorporated in the first peripheral optical zone is between 0.05 mm and 2.0 mm.

12. The lens of claim 1, wherein the width of the second peripherial optical zone is between 0.05 mm and 5.0 mm.

13. The lens claim 1, wherein the central optical zone power is at least 0.25 D more positive power than required to correct the far distance refractive error.

14. The lens of claim 1, wherein the at least one zone of the first peripheral optical zone is at least 0.125 D less positive than the central optical zone power and wherein each successive zone is 0.125 D less positive than any preceding zone.

15. The lens of claim 1, wherein the central optical zone power and/or the at least one zone of the first peripheral optical zone and/or the second peripheral optical zone power form a substantially constant power profile for any power or portion of the optical zone.

16. The lens of claim 15, wherein the portion of the optical zone that has substantially constant power profile may be 10% or more, 20% or more, 40% or more, 50% or more, or 75% or more across the power range of myopic powers and/or hyperopic powers in the range of +/−8.0 D, or +/−10.0 D or +/−15.0 D.

17. The lens of claim 1, wherein the at least one curvature forming the central optical zone and/or any of the zones of the first peripheral optical zone and/or the second peripheral optical zone is non-coaxial.

18. The lens of claim 1, wherein the at least one curvature forming the central optical zone and/or any of the zones of the first peripheral optical zone and/or the second peripheral optical zone forms on-axis and/or off-axis focal points in front of, on, and/or behind the retinal plane.

19. The lens of claim 1, wherein the at least one curvature forming the central optical zone and/or any of the zones of the first peripheral optical zone and/or the second peripheral optical zone forms a spheroidal torus.

20. The lens of claim 1, wherein the at least one curvature forming the central optical zone and/or any of the zones of the first peripheral optical zone and/or the second peripheral optical zone forms a non-spheroidal torus.

21. The lens of claim 1, wherein the at least one curvature forming the central optical zone and/or any of the zones of the first peripheral optical zone and/or the second peripheral optical zone forms a non-rotationally symmetric lens.

22. The lens of claim 1, further comprising a ballast.

23. The lens of claim 1, wherein the lens has a toric optical zone.
